(19) United States
(12) Patent Application Publication
(10) Pub. No.: US 2025/0342774 A1
(43) Pub. Date: Nov. 6, 2025

(54) Guided demo assistant

(71) Applicant: Demostack, Inc., San Francisco, CA (US)

(72) Inventors: Ben Sterenson, Raanana (IL); Rotem Maya Dantess, Ramat Gan (IL); Gonen Tiberg, Tel Aviv (IL); Noga Nahum (Gdalia), Tel Aviv (IL); Aaron Bar Hakim, Rishon Lezion (IL); Gilad Avidan, Tel Aviv (IL); Yehonatan Ernest Friedman, San Francisco, CA (US)

(21) Appl. No.: 19/198,141

(22) Filed: May 5, 2025

Related U.S. Application Data
(60) Provisional application No. 63/642,799, filed on May 5, 2024.

(51) Int. Cl. G09B 5/02; G06F 3/0484; G06F 3/14; G06T 7/70; G06T 11/60

(52) U.S. Cl. CPC G09B 5/02; G06F 3/1454; G06T 7/70; G06T 11/60; G06F 3/0484; G06T 2200/24

(57) ABSTRACT

In one embodiment, a guided demonstration method includes causing execution of a demonstration and corresponding demonstration guidance, causing rendering, to a first display, at least one user interface screen of the demonstration with the corresponding demonstration guidance superimposed over the at least one user interface screen, and causing sharing over a network of the at least one user interface screen to a remote device such that the at least one user interface screen is displayed on a second display of the remote device without the demonstration guidance.

### RELATED APPLICATION INFORMATION

The present application claims priority from U.S. Provisional Patent Application Ser. No. 63/642,799 of Sterenson, et al., filed 5 May 2024, the disclosure of which is hereby incorporated herein by reference.

### FIELD OF THE DISCLOSURE

The present disclosure relates to computer systems, and in particular, but not exclusively to, application demonstration.

### BACKGROUND

A product demonstration (i.e., “demo”) is typically used to present a software application such as business-to-business software as a service application. The product demo can be used to show the value of a software application to a current or prospective customer, and typically involves a demonstration of the application's core features and capabilities.

U.S. Pat. No. 11,909,807 of Tiberg, et al., describes a processor which executes a web browser detecting a first request including a Hypertext Transfer Protocol (HTTP) request conveyed by the web browser to a first server for a web page including browser-executable code for a web-based application, and a response received from the first server including the requested browser-executable code, wherein the first HTTP request includes a first Uniform Resource Locator (URL). In the browser-executable code, a second request to a second server for a web resource and including a second URL is identified, and the second URL in the browser-executable code is modified so as to reference a third server. The first URL is modified so as to reference a fourth server, and the modified browser-executable code is stored on the fourth server so as to be referenced by the modified first URL.

US20230114651 of Bar Hakim, et al. describes a method, including capturing, at a first time from an executing web-based application including browser-executable code, a first request including a first Uniform Resource Locator (URL) for a specified resource hosted by a first server, and conveying the request to the first server. Upon receiving, from the first server, the requested resource in response to the conveyed request, the received resource is stored to a second server referenced by a second URL different from the first URL. While executing the application at a second time subsequent to the first time, a second request for the specified resource is detected in the code. While the application is executing at the second time, the code is modified so as to reference the second URL, and the modified code is executed so as to convey the second request to the second URL.

US20230116021 of Bar Hakim, et al. describes methods, storage systems and computer program products to implement embodiments including running by a web browser, a web-based application including a set of web pages, and identifying changes in the web pages rendered by the web browser while running the web-based application. For each identified change, a corresponding state of the web-based application is recorded, wherein the corresponding state includes browser-executable code for a given web page being rendered, and one or more transitions from the corresponding state to one or more other states is also recorded. The recorded states and the recorded transitions are compiled into a state machine model of the web-based application, and a demonstration of the application is generated using the state machine model.

### SUMMARY

There is provided in accordance with an embodiment of the present disclosure, a guided demonstration method, including causing execution of a demonstration and corresponding demonstration guidance, causing rendering, to a first display, at least one user interface screen of the demonstration with the corresponding demonstration guidance superimposed over the at least one user interface screen, and causing sharing over a network of the at least one user interface screen to a remote device such that the at least one user interface screen is displayed on a second display of the remote device without the demonstration guidance.

Further in accordance with an embodiment of the present disclosure the causing sharing includes causing sharing over the network of the at least one user interface screen without the superimposed demonstration guidance to the remote device.

Still further, in accordance with an embodiment of the present disclosure, the method includes rendering the at least one user interface screen to the second display without the demonstration guidance.

Additionally in accordance with an embodiment of the present disclosure, the method includes executing the application demonstration and the corresponding demonstration guidance, rendering to the first display the at least one user interface screen with the corresponding demonstration guidance superimposed over the at least one user interface screen, and sharing over the network of the at least one user interface screen without the superimposed demonstration guidance to the remote device such that the user interface screen is displayed on the second display without the demonstration guidance.

Moreover in accordance with an embodiment of the present disclosure the causing rendering includes causing rendering to the first display the at least one user interface screen in a first layer and the corresponding demonstration guidance in a second layer with the second layer being superimposed over the first layer, and the sharing includes sharing the first layer without the second layer to the remote device such that the first layer is displayed on the second display without the second layer.

Further in accordance with an embodiment of the present disclosure, the method includes defining the second layer as a protected window that is protected from being shared to another device.

Still further in accordance with an embodiment of the present disclosure, the method includes receiving user interaction input with the at least one user interface screen to navigate within the demonstration, and updating rendering of the at least one user interface screen and the corresponding demonstration guidance to the first display responsively to the user interaction input.

Additionally in accordance with an embodiment of the present disclosure, the method includes removing from display a first element of the demonstration guidance and adding to the display a second element of the demonstration guidance responsively to the user interaction input.

Moreover, in accordance with an embodiment of the present disclosure the user interaction input includes any one or more of the following scrolling within the at least one user interface screen, navigating to a new page of the at least one user interface screen, or selecting a dropdown menu.

Further in accordance with an embodiment of the present disclosure, the method includes synchronizing rendering the at least one user interface screen and the corresponding demonstration guidance on the first display responsively to navigation of the demonstration.

Still further in accordance with an embodiment of the present disclosure, the method includes timing the rendering of a first element of the demonstration guidance to the display responsively to a time elapsed from a start of the demonstration or a time left until a planned end of the demonstration.

Additionally in accordance with an embodiment of the present disclosure the causing rendering includes causing rendering of corresponding elements of the demonstration guidance a predefined guidance display order.

Moreover, in accordance with an embodiment of the present disclosure the causing rendering includes causing rendering of an element of the demonstration guidance indicating that the demonstration has been incorrectly navigated.

Further in accordance with an embodiment of the present disclosure an element of the demonstration guidance includes a message or a tooltip or an action button, attached to an object of the at least one user interface screen.

Still further, in accordance with an embodiment of the present disclosure, the method includes, in a setup stage receiving user input to add new elements to the demonstration guidance, and adding the new elements to the demonstration guidance.

Additionally in accordance with an embodiment of the present disclosure a given element of the new elements includes a message or a tooltip or an action button, attached to an object of the at least one user interface screen.

Moreover, in accordance with an embodiment of the present disclosure, the method includes detecting a position of attachment of the given element to the object of the at least one user interface screen.

Further in accordance with an embodiment of the present disclosure, the method includes defining a guidance display order of the new elements during the rendering of the demonstration.

Still further in accordance with an embodiment of the present disclosure, the method includes defining an activation rule of the given element during the rendering of the demonstration.

Additionally in accordance with an embodiment of the present disclosure selection of the action button during execution of the demonstration is configured to perform a navigational action.

Moreover, in accordance with an embodiment of the present disclosure selection of the action button during execution of the demonstration performs an action external to the demonstration.

There is also provided in accordance with another embodiment of the present disclosure, a device, including a process configured to cause execution of a demonstration and corresponding demonstration guidance, cause rendering, to a first display, at least one user interface screen of the demonstration with the corresponding demonstration guidance superimposed over the at least one user interface screen, and cause sharing over a network of the at least one user interface screen to a remote device such that the at least one user interface screen is displayed on a second display of the remote device without the demonstration guidance, and a memory configured to store data used by the processor.

There is also provided in accordance with still another embodiment of the present disclosure, a software product, including a non-transient computer-readable medium in which program instructions are stored, which instructions, when read by a central processing unit (CPU), cause the CPU to cause execution of a demonstration and corresponding demonstration guidance, cause rendering, to a first display, at least one user interface screen of the demonstration with the corresponding demonstration guidance superimposed over the at least one user interface screen, and cause sharing over a network of the at least one user interface screen to a remote device such that the at least one user interface screen is displayed on a second display of the remote device without the demonstration guidance.

### BRIEF DESCRIPTION OF THE DRAWINGS

The present disclosure will be understood from the following detailed description, taken in conjunction with the drawings in which:

FIG. 1 is a block diagram view of a guided demonstration system constructed and operative in accordance with an embodiment of the present disclosure;

FIG. 2 is a flowchart including steps in a method of operation of the system of FIG. 1;

FIG. 3 is a schematic view illustrating layering and sharing in the system of FIG. 1;

FIG. 4 is a schematic view showing different guidance elements for use in the system of FIG. 1;

FIG. 5 is a flowchart including steps in a method of adding guidance elements to a demonstration in the system of FIG. 1; and

FIG. 6 is a view of an example user interface screen to which guidance is being added for use in the system of FIG. 1.

### DESCRIPTION OF EXAMPLE EMBODIMENTS

### Overview

As previously mentioned, a product demonstration (i.e., “demo”) is typically used to present a software application such as business-to-business software as a service application. The product demo can be used to show the value of a software application to a current or prospective customer, and typically involves a demonstration of the application's core features and capabilities.

Demonstrating software correctly challenges the presenter to demonstrate all the relevant features of the software in a limited time frame. The presenter may learn a demonstration script and hope that the relevant features and details are remembered during the demonstration. One solution is to provide demonstration guidance on screen to the presenter. If the guidance is superimposed over the demonstration, the guidance will also be seen by a viewer of the presentation. If the guidance is not superimposed over the demonstration, then the value of the guidance will be limited in providing help to the presenter.

Therefore, embodiments of the present invention, address at least some of the above drawbacks by providing a system in which demonstration guidance is rendered to the display screen of the demonstrator and superimposed over an application demonstration for view by the demonstrator, but the demonstration is shared (e.g., via a network) with the viewer without the demonstration guidance so that the viewer sees the application demonstration without the guidance. In some embodiments, the application demonstration is rendered to the display screen of the demonstrator as a first layer, and the demonstration guidance is rendered to the display screen of the demonstrator as a second layer, with the second layer being rendered over the first layer so that the guidance is superimposed over the application demonstration on the display screen of the demonstrator. The second layer is prevented from being shared by a collaboration (e.g., screen sharing) application to the viewer, for example, by defining the second layer as a protected window.

The demonstration guidance may include any one or more of the following guidance elements superimposed over the application demonstration user interface screen(s): one or more guidance messages (e.g., “select this button”, “select this menu or dropdown”, “describe the functionality of the graph”), one or more guidance tooltips which appear when hovered over, one or more action buttons (e.g., providing navigational actions such as scrolling or selecting menus or dropdowns, or pages when the buttons are selected, or sharing information with the viewer via email etc.). The elements of the guidance may be assigned a rendering order so that the guidance is rendered to the display in the assigned order, so that when one guidance element has been followed (e.g., a navigational action is performed, or a guidance element is dismissed by the presenter), that guidance element is removed from the display and the next guidance element is rendered to the display over the demonstration, and so on. A guidance element may be time activated such that the guidance element is rendered according to a time with respect to the start or end of the demonstration. For example, a guidance element may be rendered three minutes before the scheduled end time of the demonstration to remind the demonstrator to say a final message to the viewer. In some embodiments, if the presenter skips a guidance element, for example, by navigating away from a user interface screen including a guidance element without performing an action associated with that guidance element, or by performing an action related to a future guidance element (e.g., defined by the guidance rendering order), the system may render corrective guidance over the application demonstration user interface screen(s) to warn the demonstrator that the guidance item has been skipped.

In some embodiments, the guidance and the user interface screen(s) of the demonstration are synchronized so that as the presenter navigates around the demonstration, guidance elements may be added to the display or removed from the display according to the user interface screen, or part thereof, currently being rendered to the display screen of the presenter.

In a setup stage, prior to demonstrating the application, a user may add demonstration guidance elements to the demonstration optionally including activation rules (i.e., what happens if the user selects the guidance element during a demonstration), guidance order, and/or timing issues. The system may detect the positions of the elements with respect to the user interface of the demonstration application so that the elements may be rendered in the correct positions during execution of the application demonstration.

### System Description

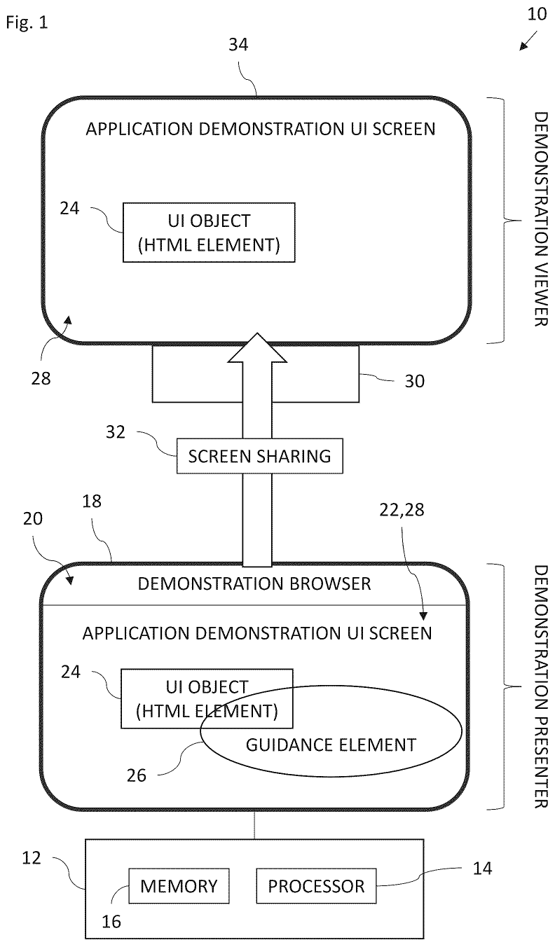

Reference is now made to FIG. 1, which is a block diagram view of a guided demonstration system 10 constructed and operative in accordance with an embodiment of the present disclosure. A local device 12 of a demonstration presenter may include a processor 14, a memory 16, and a display screen 18. The memory 16 of the device 12 is configured to store data used by the processor 14.

The processor 14 is configured to execute a demonstration browser 20 (or other demonstration support software) in which an application demonstration 22 may be executed. The application demonstration 22 may be run locally by the processor 14. In some embodiments, the application demonstration 22 may be run from a remote server (not shown), such as a cloud server, and local user interaction may be relayed by the demonstration browser 20 to remote server which is running the application demonstration 22, while user interface screen(s) 28 of the application demonstration 22 are rendered locally to the display screen 18 via the demonstration browser 20. The user interface screen(s) 28 of the application demonstration 22 may include one or more user interface objects 24 (only one shown for the sake of simplicity). The processor 14 may also render one or more guidance elements 26 (only one shown for the sake of simplicity) superimposed over the user interface screen(s) 28 of the application demonstration 22 on the display screen 18.

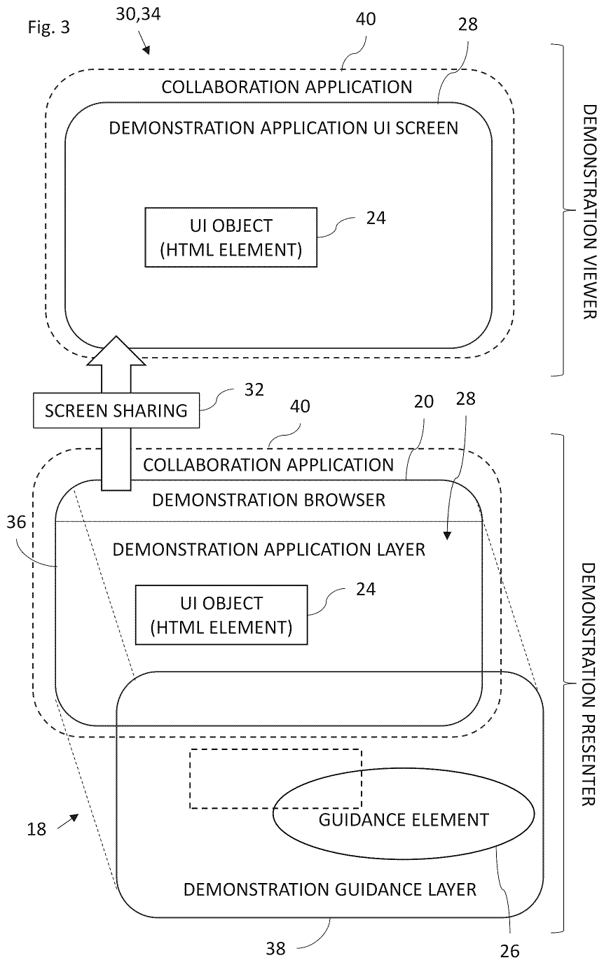

Screen sharing from the device 12 of the presenter to a device 30 of the demonstration viewer may be implemented using any suitable screen sharing application (block 32), described in more detail with reference to FIG. 3. The user interface screen(s) 28 of the application demonstration 22 are shared with the user interface objects 24 but without the guidance elements 26 by the screen sharing (block 32) to the device 30 so that device 30 may render the shared user interface screen(s) 28 to a display screen 34 of the demonstration viewer without the guidance elements 26.

In practice, some or all of these functions may be combined in a single physical component or, alternatively, implemented using multiple physical components. These physical components may comprise hard-wired or programmable devices, or a combination of the two. In some embodiments, at least some of the functions of the processor may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

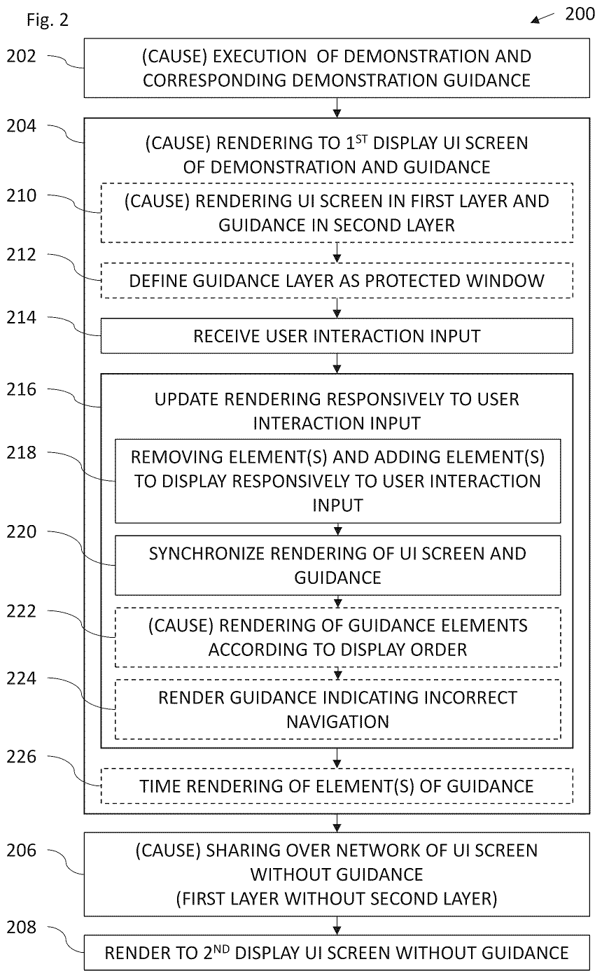

Reference is now made to FIG. 2, which is a flowchart 200 including steps in a method of operation of the system 10 of FIG. 1. Reference is also made to FIG. 1. The processor 14 is configured to execute, or cause execution of, a demonstration (e.g., application demonstration 22 in demonstration browser 20) and corresponding demonstration guidance including guidance elements 26 (block 202). The processor 14 is configured to render, or causing rendering, to display screen 18, user interface screen(s) 28 of the demonstration 22 with the corresponding demonstration guidance (e.g., guidance elements 26) superimposed over the user interface screen(s) 28 (block 204). The processor 14 is configured to share, or causing sharing of, over a network, the user interface screen(s) 28, without the superimposed demonstration guidance, to remote device 30 such that the user interface screen(s) 28 is displayed on the display screen 34 of the device 30 without the demonstration guidance (block 206). The device 30 is configured to render the user interface screen(s) 28 to the display screen 34 without the demonstration guidance (block 208). The steps of blocks 204 and 206 are described in more detail below.

Reference is now made to FIG. 3, which is a schematic view illustrating layering and sharing in the system 10 of FIG. 1. Reference is also made to FIG. 2. The processor 14 is configured to render, or cause rendering, to the display screen 18, the user interface screen(s) 28 in a demonstration application layer 36 and the corresponding demonstration guidance in a demonstration guidance layer 38 with the demonstration guidance layer 38 being superimposed (e.g., optionally with a given level of transparency) over the demonstration application layer 36 so that the guidance elements 26 are seen superimposed over the user interface screen 28. In other words, the user interface objects 24 of the user interface screen(s) 28 are rendered in the demonstration application layer 36, and the guidance elements 26 are rendered in the demonstration guidance layer 38 (block 210). In some embodiments, the processor 14 (e.g., instructed by the demonstration browser 20 running on processor 14) is configured to define the demonstration guidance layer 38 as a protected window that is protected from being shared to another device (block 212). A protected window may be implemented via an operating system (OS)-supported configuration, for example, as described at “www.electronjs.org/docs/latest/api/browser-window#winsetcontentprotectionenable-macos-windows” under which “screen sharing” applications (e.g., Zoom™) adhere to, and do not share the protected screen to another device. Therefore, in some embodiments, the step of block 206 includes the processor 14 being configured to share (block 32) demonstration application layer 36 without the demonstration guidance layer 38 to the remote device 30 such that the demonstration application layer 36 is displayed on the display screen 34 without demonstration guidance layer 38. In some embodiments, a collaboration application 40 running on the devices 12, 30 (and optionally in the cloud) is configured to share the demonstration application layer 36 from device 12 to device 30.

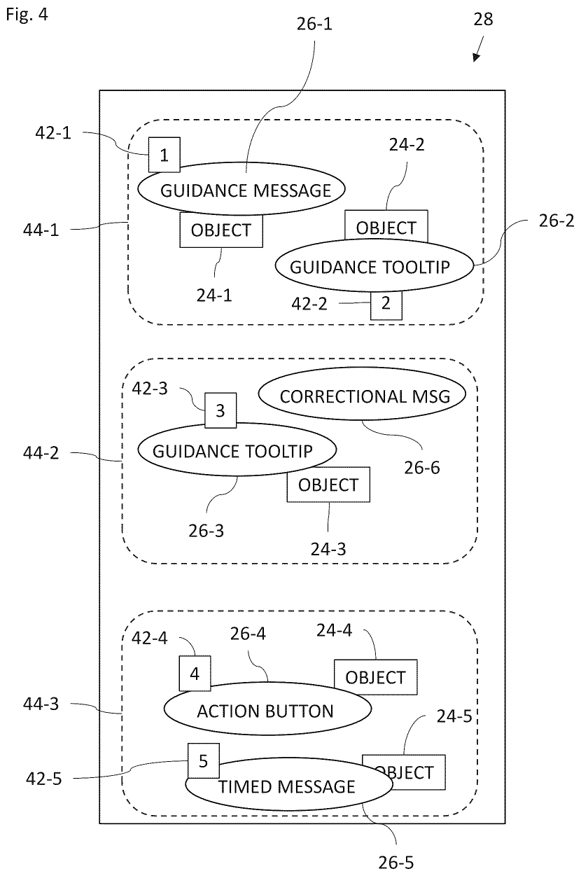

Reference is now made to FIG. 4, which is a schematic view showing different guidance elements for use in the system 10 of FIG. 1. Reference is also made to FIG. 2. One of the guidance elements 26 (labeled 26-1 to 26-6) may include a message or a tooltip or an action button, attached to one of the user interface objects 24 of the user interface screen(s) 28. FIG. 4 shows different examples of guidance elements 26. Each guidance element 26 (in the demonstration guidance layer 38) is associated with one of the user interface objects 24 (labeled 24-1 to 24-5) (in the demonstration application layer 36). In the example of FIG. 4, most of the guidance elements 26 are assigned a predefined guidance display order 42 (labeled 24-1 to 24-5). The user interface screen 28 of FIG. 4 may be scrolled up and down and frames 44 (labeled 44-1 to 44-3) depict different parts of the user interface screen 28 that may be rendered to the display screen 18 at different times depending on the navigation of the user interface screen 28 selected by the user.

The processor 14 is configured to receive user interaction input (e.g., via one or more user interfaces, e.g., mouse, keyboard, touch sensitive screen) with the user interface screen(s) 28 to navigate within the demonstration 22 (block 214). The user interaction input may include any one or more of the following: scrolling within the user interface screen(s) 28; navigating to a new page of the user interface screen(s) 28; or selecting a dropdown menu.

The processor 14 is configured to update rendering of the user interface screen(s) 28 and the corresponding demonstration guidance 26 on the display screen 18 responsively to the user interaction input (block 216). The step of block 216 may include any of the steps of blocks 218-224, described in more detail below.

The processor 14 is configured to remove from display a first element (e.g., guidance element 26-1) of the demonstration guidance and adding to the display screen a second element (e.g., guidance elements 26-2) of the demonstration guidance responsively to the user interaction input (block 218). For example, guidance element 26-1 may suggest activating a dropdown menu. Once the dropdown menu has been selected, the guidance element 26-1 may be removed from the display screen (e.g., automatically based on the action), and guidance element 26-2 may be added to the display screen. A user may dismiss one of the guidance elements 26 leading to a next one of the guidance elements 26 being rendered, e.g., according to the predefined guidance display order 42.

The processor 14 is configured to synchronize rendering the user interface screen(s) 28 and the corresponding demonstration guidance 26 on the display screen 18 responsively to navigation by the user in the demonstration (block 220). For example, when the navigation moves from frame 44-1 to frame 44-2, the guidance elements 26 shown in frame 44-1 are removed and the guidance elements 26 shown in frame 44-2 are rendered to the display screen 18.

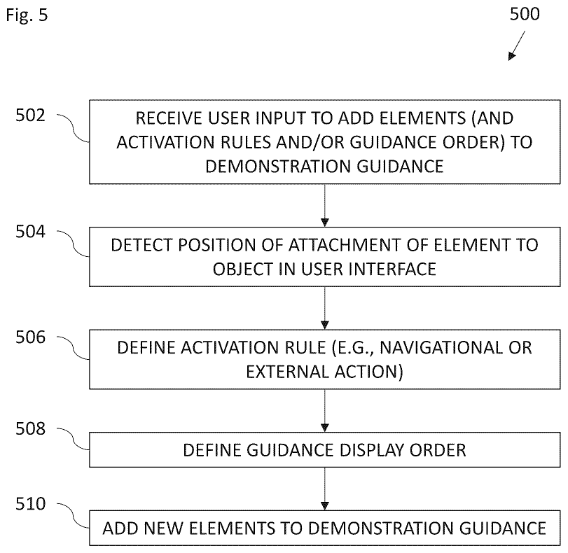

The navigation of the user interface screen(s) 28 may be tracked using any suitable method such as window re-sizing, window scrolling (e.g., “subscribe and await” described at the following link “developer.mozilla.org/en-US/docs/Web/API/Element/scrollend_event)”, tracking the HTML commands being executed and/or changes to the DOM structure and/or evaluating HTML or JavaScript object states with relevant functions. The rendering of the guidance elements 26 may be synchronized to the user interface screen(s) 28 based on the HTML commands being executed and the user interface objects 24 associated with the guidance elements 26, as described in more detail with reference to FIG. 5. In some embodiments, scrolling in, and/or resizing, the demonstration application layer 36 will result in a recalculation of which guidance element(s) 26 should be rendered currently to the display screen 18 and optionally a resizing of the guidance element(s) 26 and/or the demonstration guidance layer 38.

The processor 14 is configured to render, or cause rendering of, corresponding elements 26 of the demonstration guidance according to a predefined guidance display order (block 222). In the example of FIG. 4 the guidance elements 26 are rendered according to the predefined guidance display order 42.

In some embodiments, if the presenter skips a guidance element 26, for example, by navigating away from a part of the user interface screen(s) 28 including a guidance element without performing an action associated with that guidance element, or by performing an action related to a future guidance element (e.g., defined by the guidance rendering order), the system may render corrective guidance to the display screen 18 over the demonstration to warn the demonstrator that the guidance item has been skipped. Therefore, in some embodiments, the processor 14 is configured to render, or cause rendering, of an element of the demonstration guidance (e.g., correctional message 26-6) indicating that the demonstration has been incorrectly navigated (block 224). For example, if the user tries to ignore message 26-3 by scrolling to frame 44-3 without acting according to the message 26-3, the processor 14 may render correctional message 26-6 to the display screen 18.

A guidance element 26 may be time-activated such that the guidance element 26 is rendered according to a time with respect to the start or end of the demonstration. For example, a guidance element may be rendered three minutes before the scheduled end time of the demonstration to remind the demonstrator to say a final message to the viewer. Therefore, in some embodiments, the processor 14 is configured to time the rendering of an element of the demonstration guidance (e.g., timed message 26-5) to the display screen 18 responsively to a time elapsed from a start of the demonstration or a time left until a planned end of the demonstration (block 226). In some embodiments, the user may be able to input a start and end time and/or duration of the meeting/demonstration.

Reference is now made to FIG. 5, which is a flowchart 500 including steps in a method of adding guidance elements 26 to a demonstration in the system 10 of FIG. 1. In a setup stage, the processor 14 is configured to receive user input to add new elements 26 to the demonstration guidance (block 502). The user input may also include an activation rule (e.g., if selection of the guidance element 26 will perform an action or track an action) for each new element and/or a guidance display order. The processor 14 is configured to detect a position of attachment of a given element 26 to one of the objects 24 of the user interface screen(s) 28 (block 504), for example, based on HTML commands.

The processor 14 is configured to define an activation rule of a given one of the elements 26 during the rendering of the demonstration based on the user input (block 506). The activation rule may include defining what action is performed when the given element 26 is selected during the demonstration. In some embodiments, selection of an action button during execution of the demonstration is configured to perform a navigational action (e.g., scrolling, selecting a new screen or a dropdown menu). In some embodiments, selection of the action button during execution of the demonstration performs an action external to the demonstration, e.g., sharing information with the viewer by email. In some embodiments, real-time added-value information may be fetched and displayed to the demonstrator to further assist in an effective demonstration for the viewer, e.g., retrieving an excerpt of the viewer's company-related information and displaying this excerpt to the demonstrator in order to facilitate a more personalized demonstration/explanation by the demonstrator.

The processor 14 is configured to define a guidance display order of the new elements 26 during the rendering of the demonstration based on the user input (block 508). The new elements 26 may be assigned a default guidance display order according to the order in which the new elements 26 are added by the user. The default order may then be updated by the user.

The processor 14 is configured to add the new elements 26 to the demonstration guidance (block 510). The new elements 26 may be selected from any one or more of the following: a message; a tooltip; or an action button. The new elements may be attached to respective objects 24 of the user interface screen(s) 28.

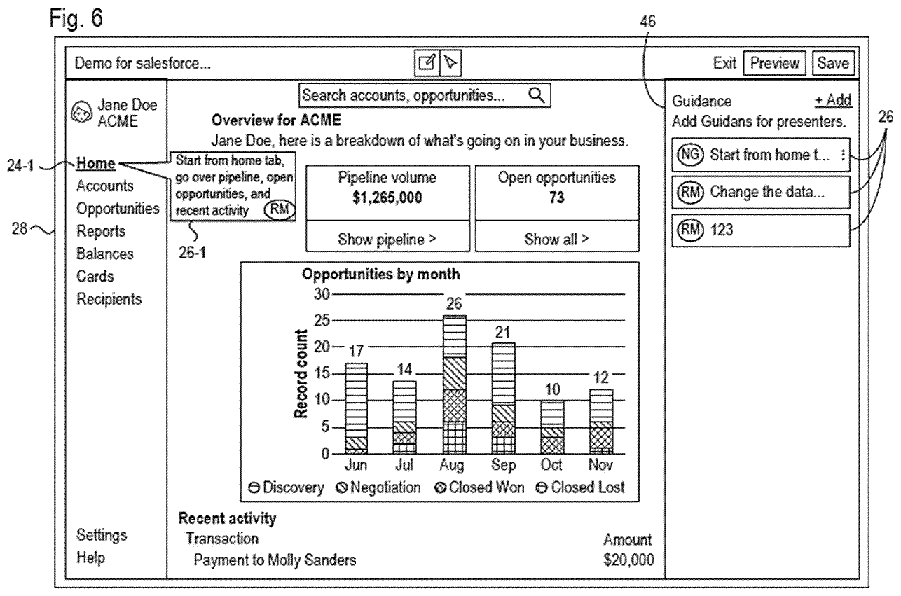

Reference is now made to FIG. 6, which is a view of an example user interface screen 28 to which guidance 26 is being added for use in the system 10 of FIG. 1. The guidance element 26-1 has been attached to user interface object 24-1. FIG. 6 also shows a setup menu 46 listing the guidance display order of all the guidance elements 26 added to the user interface screen 28.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A guided demonstration method, comprising:
causing execution of a demonstration and corresponding demonstration guidance;
causing rendering, to a first display, at least one user interface screen of the demonstration with the corresponding demonstration guidance superimposed over the at least one user interface screen; and
causing sharing over a network of the at least one user interface screen to a remote device such that the at least one user interface screen is displayed on a second display of the remote device without the demonstration guidance.

2. The method according to claim 1, wherein the causing sharing includes causing sharing over the network of the at least one user interface screen without the superimposed demonstration guidance to the remote device.

3. The method according to claim 1, further comprising rendering the at least one user interface screen to the second display without the demonstration guidance.

4. The method according to claim 1, further comprising:
executing the application demonstration and the corresponding demonstration guidance;
rendering to the first display the at least one user interface screen with the corresponding demonstration guidance superimposed over the at least one user interface screen; and
sharing over the network of the at least one user interface screen without the superimposed demonstration guidance to the remote device such that the user interface screen is displayed on the second display without the demonstration guidance.

5. The method according to claim 1, wherein:
the causing rendering includes causing rendering to the first display the at least one user interface screen in a first layer and the corresponding demonstration guidance in a second layer with the second layer being superimposed over the first layer; and
the sharing includes sharing the first layer without the second layer to the remote device such that the first layer is displayed on the second display without the second layer.

6. The method according to claim 5, further comprising defining the second layer as a protected window that is protected from being shared to another device.

7. The method according to claim 1, further comprising:
receiving user interaction input with the at least one user interface screen to navigate within the demonstration; and
updating rendering of the at least one user interface screen and the corresponding demonstration guidance to the first display responsively to the user interaction input.

8. The method according to claim 7, further comprising removing from display a first element of the demonstration guidance and adding to the display a second element of the demonstration guidance responsively to the user interaction input.

9. The method according to claim 7, wherein the user interaction input includes any one or more of the following: scrolling within the at least one user interface screen; navigating to a new page of the at least one user interface screen; or selecting a dropdown menu.

10. The method according to claim 7, further comprising synchronizing rendering the at least one user interface screen and the corresponding demonstration guidance on the first display responsively to navigation of the demonstration.

11. The method according to claim 1, further comprising timing the rendering of a first element of the demonstration guidance to the display responsively to a time elapsed from a start of the demonstration or a time left until a planned end of the demonstration.

12. The method according to claim 1, wherein the causing rendering includes causing rendering of corresponding elements of the demonstration guidance according to a predefined guidance display order.

13. The method according to claim 1, wherein the causing rendering includes causing rendering of an element of the demonstration guidance indicating that the demonstration has been incorrectly navigated.

14. The method according to claim 1, wherein an element of the demonstration guidance includes a message or a tooltip or an action button, attached to an object of the at least one user interface screen.

15. The method according to claim 1, further comprising, in a setup stage:
receiving user input to add new elements to the demonstration guidance; and
adding the new elements to the demonstration guidance.

16. The method according to claim 15, wherein a given element of the new elements includes a message or a tooltip or an action button, attached to an object of the at least one user interface screen.

17. The method according to claim 16, further comprising detecting a position of attachment of the given element to the object of the at least one user interface screen.

18. The method according to claim 16, further comprising defining a guidance display order of the new elements during the rendering of the demonstration.

19. The method according to claim 16, further comprising defining an activation rule of the given element during the rendering of the demonstration.

20. The method according to claim 16, wherein selection of the action button during execution of the demonstration is configured to perform a navigational action.

21. The method according to claim 16, wherein selection of the action button during execution of the demonstration performs an action external to the demonstration.

22. A device, comprising:
a process configured to:
cause execution of a demonstration and corresponding demonstration guidance;
cause rendering, to a first display, at least one user interface screen of the demonstration with the corresponding demonstration guidance superimposed over the at least one user interface screen; and
cause sharing over a network of the at least one user interface screen to a remote device such that the at least one user interface screen is displayed on a second display of the remote device without the demonstration guidance; and
a memory configured to store data used by the processor.

23. A software product, comprising a non-transient computer-readable medium in which program instructions are stored, which instructions, when read by a central processing unit (CPU), cause the CPU to:
cause execution of a demonstration and corresponding demonstration guidance;
cause rendering, to a first display, at least one user interface screen of the demonstration with the corresponding demonstration guidance superimposed over the at least one user interface screen; and
cause sharing over a network of the at least one user interface screen to a remote device such that the at least one user interface screen is displayed on a second display of the remote device without the demonstration guidance.
